(19) United States
(12) Patent Application Publication
(10) Pub. No.: US 2016/0292789 A1
(43) Pub. Date: Oct. 6, 2016

(54) AUTOMATED REGULATORY COMPLIANCE FOR INSURANCE

(71) Applicant: Accenture Global Services Limited, Dublin (IE)

(72) Inventors: Srinivasan Krishnan Rajagopalan, Chennai (IN); Venkatesan Kamalakannan, Chennai (IN); Peter Ashly, Chennai (IN)

(21) Appl. No.: 14/715,659

(22) Filed: May 19, 2015

(30) Foreign Application Priority Data
Mar. 30, 2015 (IN) 1618/CHE/2015

(51) Int. Cl. G06Q 40/08

(52) U.S. Cl. CPC G06Q 40/08

(57) ABSTRACT

Methods, systems, and apparatus, including computer programs encoded on a computer storage medium, are described that enable automated review and tracking of compliance of documents with respect to one or more rules or regulations, and, if a deficiency in compliance is detected, automated performance of remedial actions to enable compliance. Flood protection certificate information associated with a property, as well as one or more rules related to the flood protection certificate information, are identified. A compliance status of the flood protection certificate information is automatically determined based on the one or more rules. A result of determining the compliance status of the flood protection certificate information with the one or more rules is then provided.

### CROSS-REFERENCE TO RELATED APPLICATIONS

Pursuant to 35 U.S.C. §119(a), this application claims the benefit of an earlier filing date and right of priority to Indian Patent Application No. 1618/CHE/2015, filed on Mar. 30, 2015, the contents of which are incorporated by reference herein in their entirety.

### TECHNICAL FIELD

This specification generally relates to automated reviewing, tracking, and enabling of compliance.

### BACKGROUND

Computerized systems enable processing of documents to determine the content and nature of the documents. For example, some computerized systems use optical character recognition (OCR) to extract information about textual content in documents, and/or image processing techniques to extract information about image content in documents. A computerized system may then perform processing on the extracted textual or image information to determine the nature of the documents' contents.

### SUMMARY

This specification generally relates to systems and techniques that perform automated review and tracking of compliance of documents with respect to one or more rules or regulations, and, if a deficiency in compliance is detected, automatically perform remedial actions to enable compliance.

In one aspect, a computer-implemented method is executed by one or more processors. The method includes identifying flood protection certificate information associated with a property and identifying one or more rules related to the flood protection certificate information. The method also includes automatically determining a compliance status of the flood protection certificate information based on the one or more rules. The method further includes providing a result of determining the compliance status of the flood protection certificate information with the one or more rules.

In some implementations, identifying the flood protection certificate information includes obtaining information related to at least one of a flood zone, a flood protection policy period, a flood protection limit, a flood protection deductible, or a lapse in flood protection coverage.

In some implementations, identifying the flood protection certificate information includes automatically recognizing the flood protection certificate information based on one or more naming conventions associated with flood protection policies.

In some implementations, obtaining one or more rules that are relevant to the flood protection certificate information includes retrieving, from one or more remote computer servers, information related to a government law or a government regulation related to the flood protection certificate information.

In some implementations, determining a compliance status of the flood protection certificate information with the one or more rules includes determining, based on the information related to the government law or government regulation, flood hazard data that indicates one or more flood risk zones. The method further includes comparing a geographic location of the property with the one or more flood risk zones, and determining a designated flood protection premium or a designated flood protection rate for the property based on comparing a geographic location of the property with the flood risk zones. The method further includes determining whether the flood protection certificate information complies with the designated flood protection premium or the designated flood protection rate for the property.

In some implementations, determining a compliance status of the flood protection certificate information with the one or more rules includes determining whether the property complies with a requirement to purchase flood protection as a result of receiving flood-related financial assistance from a federal government.

In some implementations, determining a compliance status of the flood protection certificate information with the one or more rules includes automatically identifying one or more parameters of the flood protection certificate information; and determining whether the one or more parameters of the flood protection certificate information satisfies the one or more rules.

In some implementations, automatically identifying one or more parameters of the flood protection certificate information includes automatically determining, based on the flood protection certificate information for the property, one or more parameters related to a flood zone, a flood protection policy period, a flood protection limit, a flood protection deductible, or a lapse in flood protection coverage.

In some implementations, determining a compliance status of the flood protection certificate information with the one or more rules includes determining that the property is not associated with a valid flood protection certificate.

In some implementations, the method further includes displaying, on a display of a mobile electronic device, a graphical user interface displaying information regarding a progress of determining a compliance status of the flood protection certificate information with the one or more rules.

In some implementations, providing the result of determining the compliance status of the flood protection certificate information with the one or more rules includes transforming a template letter to indicate the result of determining the compliance status of the flood protection certificate information; and automatically generating a postal transmission of the transformed template letter indicating the result of determining the compliance status of the flood protection certificate information, wherein the postal transmission is addressed to contact information associated with the property.

In some implementations, providing the result of determining the compliance status of the flood protection certificate information with the one or more rules includes transmitting, over an electronic network to an electronic device associated with the property, the result of determining the compliance status of the flood protection certificate information with the one or more rules.

In some implementations, providing the result of determining the compliance status of the flood protection certificate information with the one or more rules includes transmitting information indicating at least one deficiency of the flood protection certificate information with respect to the one or more rules and at least one corrective action associated with the at least one deficiency.

In some implementations, the method further includes obtaining updated flood protection certificate information associated with the property; determining that the updated flood protection certificate information does not comply with the one or more rules; and based on determining that the updated flood protection certificate information does not comply with the one or more rules, generating a force-placed flood protection certificate for the property.

In some implementations, generating a force-placed flood protection certificate for the property includes determining, based on the one or more rules, a flood protection premium for the property; and generating a flood protection certificate for the property based on the flood protection premium.

In some implementations, the method further includes determining a cancellation of the force-placed flood protection certificate; and generating a reimbursement for the flood protection premium associated with the force-placed flood protection certificate.

In some implementations, the method further includes generating, for a plurality of properties, a prioritized ordering of analyzing flood protection certificate information for the plurality of properties.

In some implementations, generating the prioritized ordering includes performing predictive analytics that identifies one or more high-risk properties from among the plurality of properties.

All or part of the features described throughout this application can be implemented as a computer storage medium encoded with a computer program, the computer program including instructions that are executable by one or more processors. All or part of the features described throughout this application can be implemented as an apparatus, method, or electronic system that can include one or more processing devices and memory to store executable instructions to implement the stated functions.

The details of one or more implementations are set forth in the accompanying drawings and the description below. Other features will be apparent from the description and drawings, and from the claims.

### BRIEF DESCRIPTION OF DRAWINGS

FIG. 1 is a block diagram illustrating an example of a system that can execute implementations of the present disclosure;

FIG. 2 is a block diagram illustrating an example of components of a system that automatically reviews, tracks, and enables compliance;

FIG. 3 is a flow chart illustrating an example of automatically reviewing, tracking, and enabling compliance;

FIG. 4 is a flow chart illustrating an example of automatically reviewing, tracking, and enabling compliance in the context of flood protection policies;

FIG. 5 is a schematic diagram illustrating an example of an input/output relationship in a system that automatically reviews, tracks, and enables compliance in the context of flood protection policies;

FIG. 6 is a schematic diagram illustrating an example of a framework and capabilities of a system that automatically reviews, tracks, and enables compliance in the context of flood protection policies;

FIGS. 7 to 9 are examples of graphical user interfaces (GUIs) that may be used by a system that automatically reviews, tracks, and enables compliance in the context of flood protection policies;

FIGS. 10 to 12 are flow charts illustrating examples of automatically reviewing, tracking, and enabling compliance in the context of flood protection policies; and

FIG. 13 is a schematic diagram of an example of a computer system that can be used for the operations described in association with the techniques described herein.

In the following text, a detailed description of examples will be given with reference to the drawings. It should be understood that various modifications to the examples may be made. In particular, elements of one example may be combined and used in other examples to form new examples. Like reference symbols in the various drawings indicate like elements.

### DETAILED DESCRIPTION

Techniques according to the present disclosure automatically review, track, and enable compliance with respect to one or more rules or regulations. The techniques may be implemented in systems, methods, computer-readable media, or other forms as described herein. For example, a system according to the present disclosure may automatically review one or more documents associated with an entity and determine whether the documents comply with a set of rules or regulations. If the system detects non-compliance in the documents, then the system may perform one or more remedial actions to enable compliance, such as alerting one or more entities associated with the documents, for example by sending instructions on how to comply with the rules and regulations, and monitoring and reviewing corrections to the documents. In some implementations, if the entity associated with the non-compliant document fails to comply with the rules and regulations, then the system may take further remedial actions, such as automatically generating, on behalf of the entity, a policy that is compliant with the rules and regulations.

As an example, a document may be related to protection of a property against loss or damages. The property may be a piece of land, a vehicle, a non-physical property, or other types of property that can be protected against loss or damage. The document may include a protection certificate that reflects specific details regarding the type and scope of protection for the property. In some cases, an entity may be required to possess a particular type of protection certificate, for example, according to governmental or private rules and regulations.

As a specific example, a protection certificate may be a flood protection certificate that protects, or insures, a property against water damage caused by floods. An entity, such as a homeowner or business, may be required to possess a particular type of flood protection certificate for various reasons. This requirement may be imposed, for example, by a governmental or private institution. For example, a homeowner who obtains a loan, or mortgage, from a private mortgage institution to purchase a piece of land in a high-risk flooding area may be required by the private mortgage institution to obtain a flood protection certificate. As another example, a business owner who receives flood-related financial assistance from a governmental institution may be required to obtain a flood protection certificate for the business.

However, an institution that imposes a requirement on a homeowner or business to possess a flood protection certificate may face difficulties in verifying and/or enforcing compliance. Non-compliance may be caused by various reasons. For example, the homeowner or business may possess an incomplete flood protection certificate, or may possess a flood protection certificate that has not been updated to reflect changes in the law, or may not possess a flood protection certificate at all. In such cases, a regulating institution, which may deal with a large number of homeowners or businesses, may face challenges not only in determining whether a particular flood protection certificate is fully compliant with potentially complex laws and regulations, but also in ensuring that any deficiencies in a non-compliant certificate are promptly corrected.

Systems and techniques according to the present disclosure automatically review and track compliance of a flood protection certificate with respect to a set of rules and regulations, and automatically enable remedial actions to correct deficiencies in the flood protection certificate. As such, the system may help mitigate the challenges described above by improving the efficiency and turnaround time of processing a flood insurance certificate, as well as by creating controls that enable an entity to more easily comply with the rules and regulations.

As an example, the system may monitor and enable compliance of flood insurance certificates with respect to a governmental law, such as the Biggert Waters Flood Act. The system may thus help mitigate violations and subsequent penalties of the governmental law. In some cases, the system may automatically generate, as result of the compliance review and tracking, audit information that may be used by governmental entities, such as Office of the Comptroller of the Currency (OCC) conducting audits of a flood insurance certificate.

The system may perform one or more types of analysis to review and track compliance. In some implementations, an insurance tracking and compliance (ITAC) system may be modified to include additional controls identified through flood intervention control. The system may generate automated flood recon reports developed in the ITAC system to monitor the status of a flood protection certificate at different stages of compliance review.

As such, the system may enable a client, such as a mortgage-issuing institution, to more efficiently and more accurately conduct and track compliance reviews of flood protection certificates, such as those held by borrowers of mortgages. The system may access data related to appropriate laws, rules, and/or regulations to automatically analyze compliance of the borrower's flood protection certificate. The system may automatically report the findings of the analysis to the client, such as the mortgage-issuing institution. In some implementations, the system may utilize a mobile-based platform to provide results and real-time tracking of the compliance review to mobiles devices of the client.

In some cases, if an entity, such as a mortgage borrower, consistently fails to comply or fails to take action to correct deficiencies in a flood protection certificate, then the system may automatically perform intervention controls to ensure compliance. For example, the system may generate, or “force-place,” a compliant flood protection certificate for the non-compliant borrower and charge the borrower with a premium for the new flood protection certificate. As such, the system may help ensure that federal laws and/or private regulations are not violated, potentially resulting in savings for the client, such as the mortgage-issuing institution. In some cases, the system may determine that a forced-placed flood protection certificate was incorrectly generated, and in such scenarios, the system may automatically generate a force-place cancellation report to enable efficient and speedy reimbursement of the force-placed premium back to the borrower.

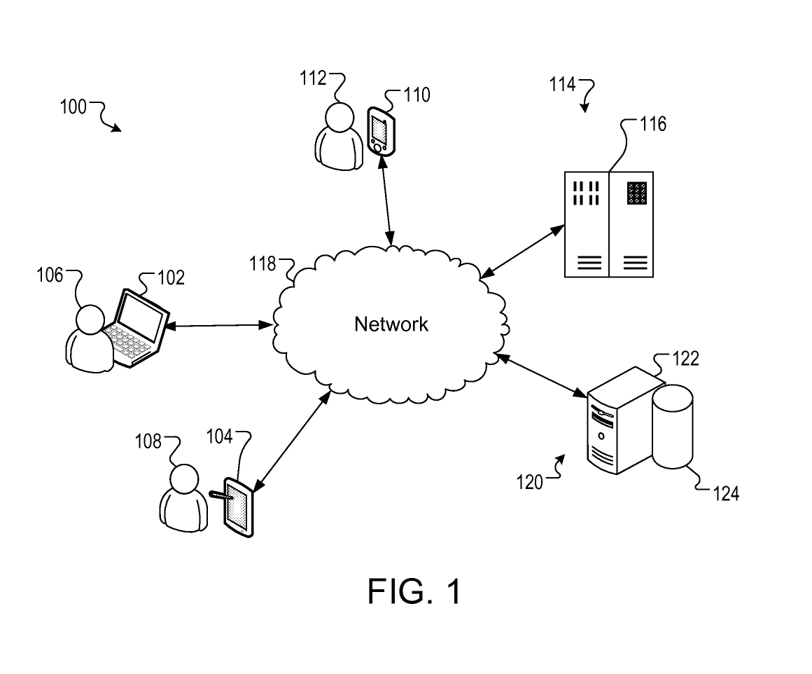

FIG. 1 depicts an example system 100 in which implementations of the present disclosure may be implemented. In the example system 100 of FIG. 1, client devices 102 and 104, operated by users 106 and 108, respectively, may execute a mobile compliance review, tracking, and enablement platform. For example, users 108 and 108 may be employees of a governmental institution, a mortgage-issuing institution, or other entity that attempts to verify compliance of a flood protection certificate.

The system may review and track compliance of flood protection certificates and provide instructions to associated agents, such as borrowers of mortgages, regarding results of the review and, in some cases, recommended actions to take in order to achieve compliance. For example, in the example of FIG. 1, the system may transmit results of the compliance review and compliance instructions to one or more electronic devices, such as electronic device 110 operated by user 112. The system may utilize any suitable form of communication to transmit the information to the user 112, such as a phone call, email, text message, etc. In some cases, the system may transmit the information to the user 112 by non-electronic techniques, such as by postal mail.

In some implementations, there may additionally be one or more remote systems, such as remote system 114, including a computer server, such as computer server 116 in FIG. 1. An the remote system 114 may be, for example, a governmental system that stores various laws, rules, and regulations associated with determining compliance of a flood protection certificate. In some implementations, the remote system 114 may be operated by a private institution, such as the mortgage-issuing institution, and may store one or more rules or regulations that may be used to determine compliance of a borrower's flood protection certificate. The remote system 114 may be implemented as one or more servers, located at a central facility or distributed across diverse geographic locations, such as a cloud-based storage system.

In some implementations, the computing devices 102, 104, and/or 110 are computing devices, such as laptop or desktop computers, smartphones, personal digital assistants, wearable computers, portable media players, tablet computers, or other appropriate computing devices that can be used to communicate with an electronic communication network, such as electronic communication network 118 in FIG. 1. In addition, one or more of the computing devices 102, 104, and/or 110 may perform client-side operations, as discussed in further detail herein.

In some implementations, the automated compliance review, tracking, and enablement platform may be hosted by a system, such as host system 120 in FIG. 1. The host system 120 may be physically located at a remote location, such as a central business center or cloud server. In some implementations, the host system 120 may provide client-side information that is downloaded on web browsers or applications executed on the computing devices 102, 104, and/or 110.

The host system 120 may include one or more servers, such as server 122, and one or more storage devices, such as storage device 124, storing computer-readable instructions. The server 122 may communicate, as needed, with the computing devices 102, 104, and/or 110 executing the automated compliance review, tracking, and enablement platform. For example, in some implementations, the host system 120 may, in addition to providing client-side software for download by the computing devices 102, 104, and/or 110, additionally store server-side information that is used by the automated compliance review, tracking, and enablement platform. The host system 120 may communicate with the computing devices 102, 104, and/or 110 by a communication medium, such as a communication network 118.

In some implementations, the network 118 is a public communication network, such as, for example, the Internet, cellular data network, or a telephone network accessed via dialup modems. The network 118 may also be a private communications network, such as, for example, private LAN, leased lines. The network 118 may include one or more networks. The network(s) may provide for communications under various modes or protocols, such as, for example, Wi-Fi. Global System for Mobile communication (GSM) voice calls, Short Message Service (SMS), Enhanced Messaging Service (EMS), or Multimedia Messaging Service (MMS) messaging, Code Division Multiple Access (CDMA), Time Division Multiple Access (TDMA), Personal Digital Cellular (PDC), Wideband Code Division Multiple Access (WCDMA), CDMA2000, General Packet Radio System (GPRS), among others. For example, the communication may occur through a radio-frequency transceiver. In addition, short-range communication may occur, such as using a BLUETOOTH, Near Field Communications (NFC), or other such transceiver.

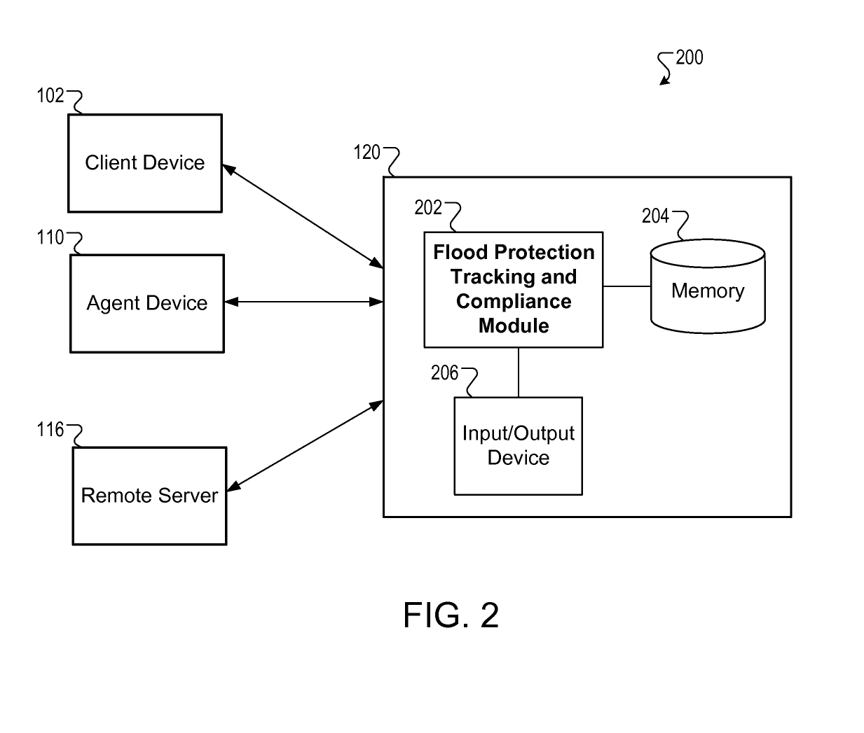

FIG. 2 depicts an example of components of a system 200 that performs automated compliance review, tracking, and enablement. In the example of FIG. 2, the system 200 includes a host system 120. The host system 120 may include a flood protection tracking and compliance device 202. The flood protection tracking and compliance device 202 may include, or communicate with, one or more processors and one or more storage devices that are configured to implement automated flood protection tracking and compliance review. For example, the flood protection tracking and compliance device 202 may utilize one or more memory modules 204 to store data related to flood protection tracking and compliance, or other information. The flood protection tracking and compliance device 202 may also receive inputs from users, such as users 106, 108, 112, or other users. For example, the flood protection tracking and compliance device 202 may use one or more input/output devices 206 to communicate information with other devices, such as client device 102, the agent device 106, and the remote server 116.

The flood protection tracking and compliance device 202 may be a module that is added to a general purpose computer to create a modified computer that achieves the functionality described. In some implementations, the flood protection tracking and compliance device 202 includes specialized hardware that is designed to control operations of other components of the flood protection tracking and compliance system 200. The flood protection tracking and compliance device 202 may interact with one or more other specialized components (which may include specialized hardware) to achieve the functionality described.

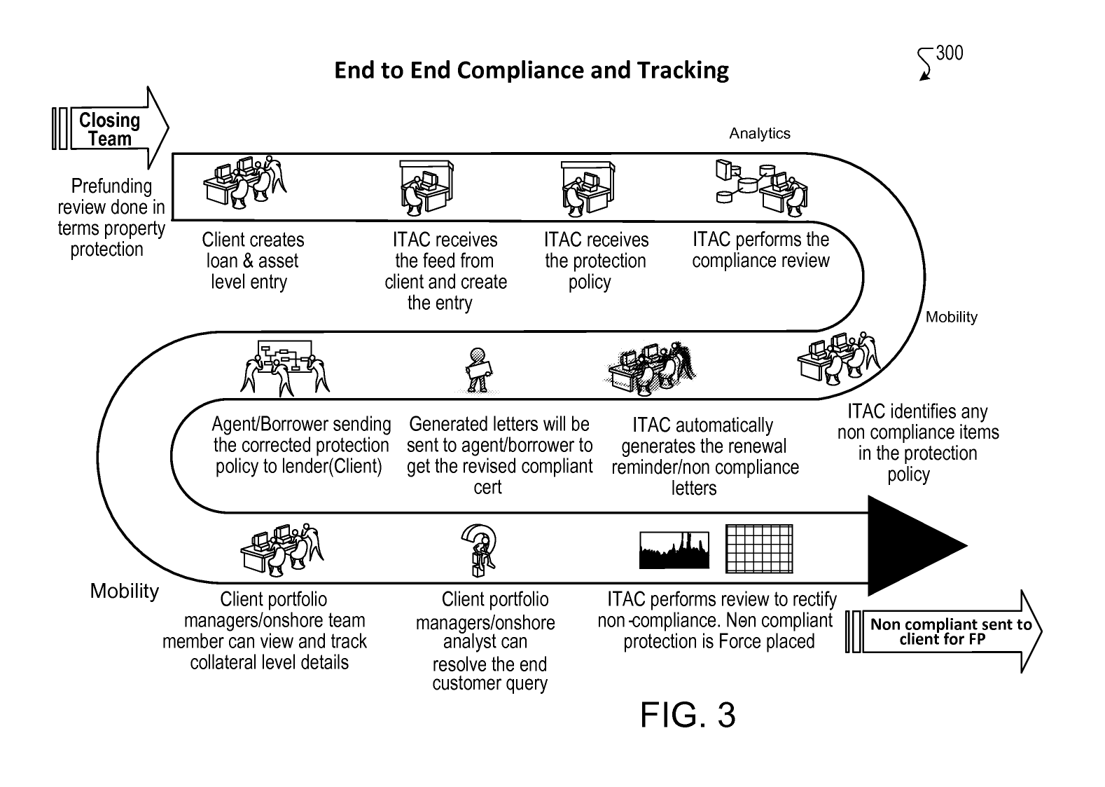

FIG. 3 depicts an example of a process of end to end compliance and tracking of property protection policies. The example process 300 in FIG. 3 illustrates an insurance tracking and compliance (ITAC) system that may be used as a tracking tool for commercial mortgage insurance. The ITAC system may have built in tracking and reporting for workflow, quality and productivity. The ITAC system may be built on any suitable server technology and may be accessible, for example, online through a browser.

In the example of FIG. 3, the ITAC system may be used to track insurance compliance status, perform invoice processing, and/or perform lender force placements for different kinds of mortgage insurances, such as, general property insurance (theft, fire, etc.), mortgage insurance, flood insurance, homeowner insurance, and/or hazard insurance. In some cases, the ITAC system may be implemented as a Web based application. Such scenarios may offer smaller initial set-up effort and easy access for clients. In some implementations, the system may provide integrated email capability that helps reducing the cycle time for correspondence. The easily customizable web interface along with robust reporting capabilities provided by the ITAC system may facilitate lenders to monitor the status of property insurance for various mortgagees.

The ITAC workflow may provide a real time status tracking of each loan along with imaging repository capabilities. The ITAC system may be capable of performing data validation and create workflows based on the priority of the loans for insurance compliance audit. The system may use integrated pre-defined letters templates to send the correspondence to the borrowers during pre- and post-insurance expiration campaigns. The ITAC system may support insurance invoice processing to extend the insurance coverage. In some cases, the ITAC system may be enable configuration with a lender based on portfolio requirements to conduct insurance status tracking audits.

The ITAC system may also have built-in analytics to enable the lender to initiate force placements to keep the properties insured and to safe guard the interest of the lender. In some cases, the system may use a built-in data reconciliation engine that provides timely reporting at various lender levels and portfolio levels with a status of collaterals whose insurance is covered, expired, uncovered, as well as cover outstanding exceptions and lender force placements. The system may also be capable of performing portfolio level analytics and recommend institutions or lenders for group insurance.

The example process of insurance tracking and compliance in FIG. 3 includes two phases of processing. One phase involved tracking information from insurance certificates into the ITAC application, and the second phase involves reviewing the tracked information against one or more rules or regulations and detecting any non-compliance.

In the first phase, a client such as a mortgage-issuing institutions receives a prefunding review for property protection and creates a loan and asset level entry (302). The ITAC system receives the feed from the client and creates an entry (304). The ITAC system then receives the protection policy associated with the loan from the client (306).

In the second phase, the ITAC system performs analytics to perform compliance review of the protection policy (308). The ITAC system identifies any non-compliance in the protection policy (310) and automatically generates alerts, such as renewal reminders and/or non-compliance letters, which are sent to the agent or borrower of the loan (314). The agent or borrower of the loan may then correct the protection policy based on the letters send the correct protection policy to the lender (316). The client may then view and track the collateral level details of the protection policy (318) and resolve the end customer query (320). The ITAC system then performs one or more actions to rectify non-compliance. For example, the ITAC system may force-place a protection policy for a loan if the agent or borrower fails to rectify non-compliance.

Further details of the compliance review process in the specific context of flood protection policies are presented next.

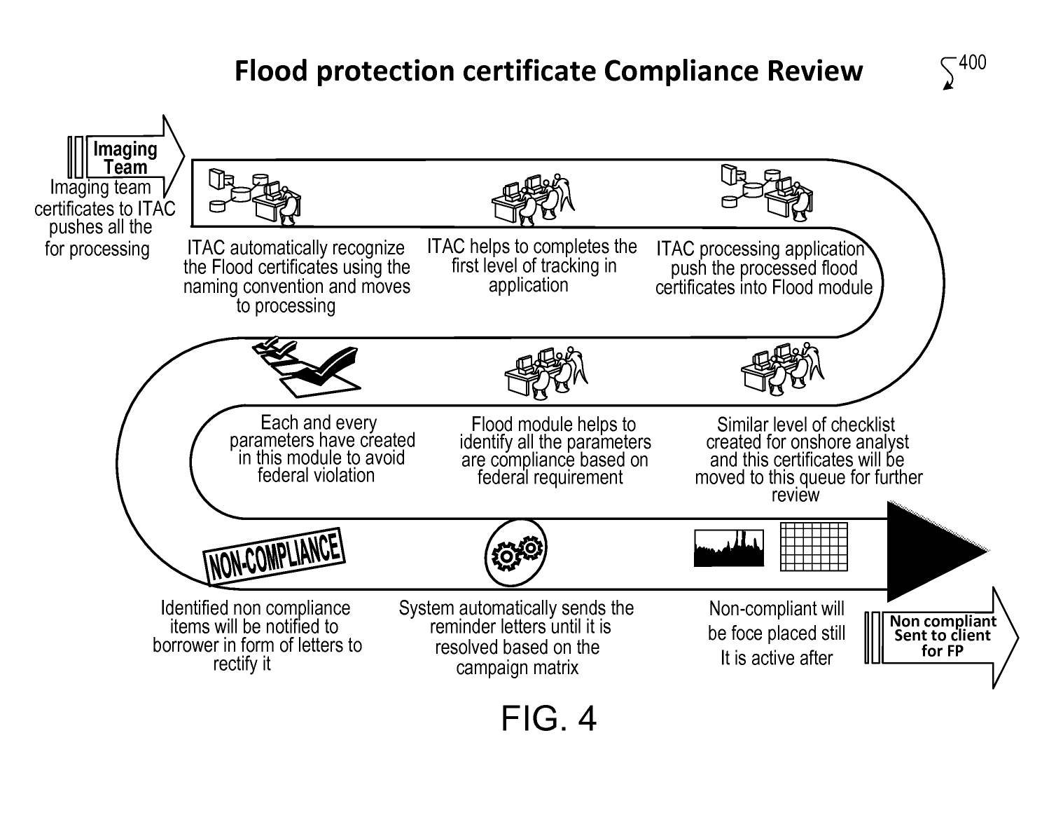

FIG. 4 depicts an example of details of a compliance review of a flood protection certificate. In the example process 400 of FIG. 4, the flood insurance module tracks the progress of reviewing the compliance of flood protection certificates by using a checklist and checkpoints that monitor governmental parameters and guidelines, such as Federal Emergency Management Agency (FEMA) regulations.

The ITAC system receives flood protection certificates for analysis (e.g., as in operation 306 of FIG. 3). The ITAC system automatically recognizes the flood protection certificates, for example by using a naming convention for flood protection policies (402). The ITAC system then performs a first level of tracking (404) and processes the flood protection certificates (406). The flood insurance module creates a checklist (408) and identifies parameters that are relevant to determining compliance of the flood protection certificates (410).

The flood insurance module checks the parameters for compliance with the FEMA regulations (412), identifies any non-compliant items and notifies the borrower of the loan about the non-compliant items in the form of letters (414). The letters may also recommend one or more actions to remedy the deficiencies. The ITAC system then automatically sends the reminder letters to the borrowers until the noted deficiencies are resolved (416). Any non-compliant items that remain and that are not resolved by the borrower may be force-placed by the flood module (418).

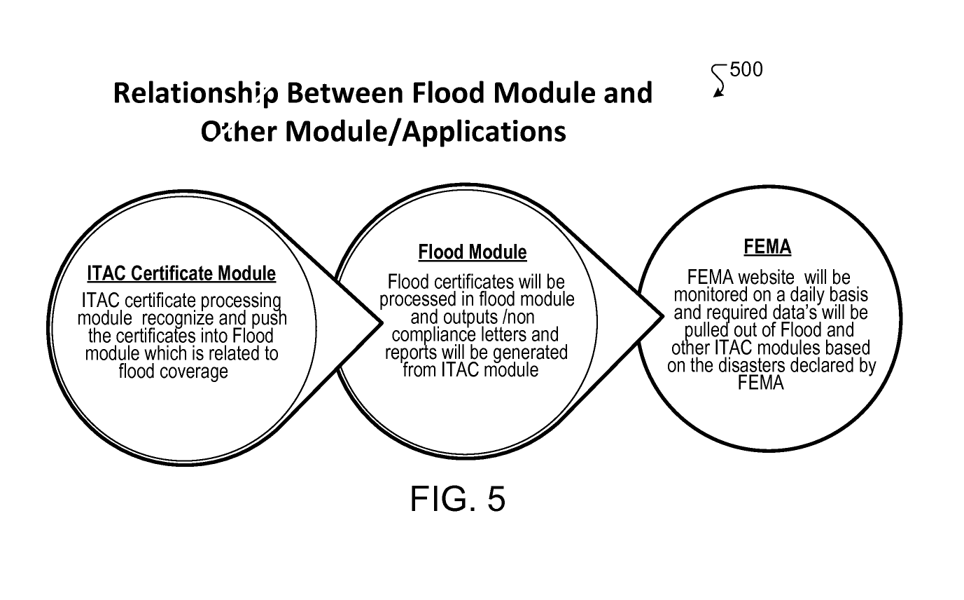

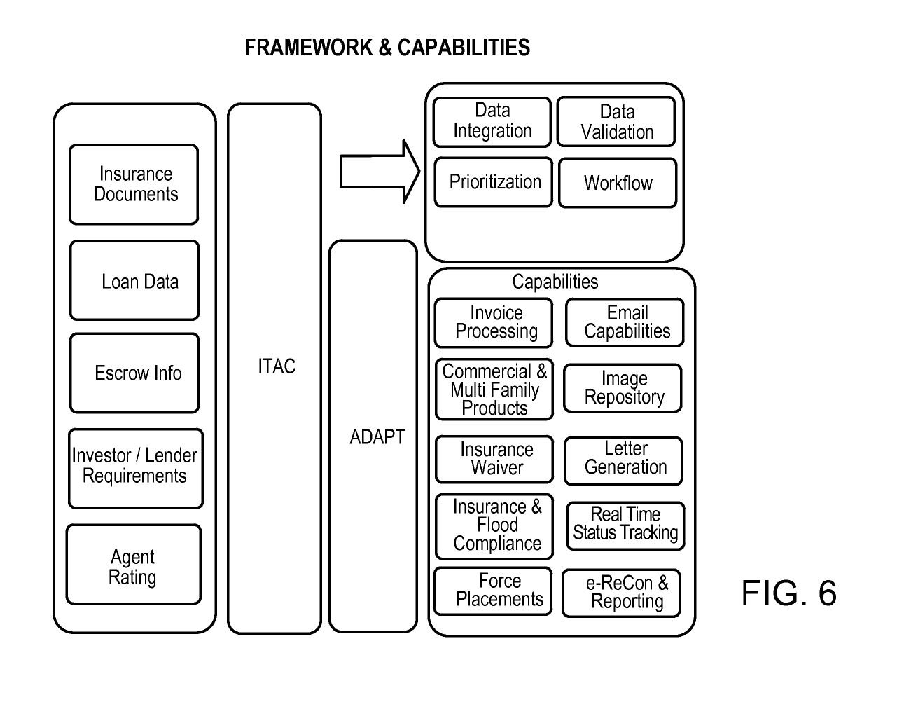

FIG. 5 is a schematic illustration of an example of a relationship between the flood insurance module and other modules and systems in the overall compliance and review system. In the example relationship 500 of FIG. 5, an ITAC Certificate Module 502 recognizes and pushes flood protection certificates into a Flood Module 504 to analyze compliance with one or more rules related to flood coverage.

The Flood Module 504 processes the flood protection certificates and outputs non-compliance letters for any items that are not in compliance with the rules and regulations. The Flood Module 504 may also generate reports and letters regarding the detected non-compliant items in the flood protection certificates.

The Flood Module 504 may obtain the rules and regulations, for example, from an external server, such as FEMA server 506. In this example, the Flood Module 504 monitors the FEMA website on a daily basis, and pulls relevant data from the Flood Module 504 and ITAC Module 502 based on disasters declared by FEMA.

FIG. 6 depicts an example of a framework and capabilities of a system that tracks compliance of a flood protection certificate. In the example framework 600 of FIG. 6, an ITAC system is built on an Architecture for Dynamic Allocation and Performance Tracking (ADAPT) framework. The ADAPT framework may provide a flexible platform that enables automated tracking of performance of various types of systems and processes. The ITAC system may take various types of information as input, such as insurance documents, loan data, escrow information, investor/lender requirements, and/or agent ratings. The ITAC system may perform different analytics to perform compliance review of the insurance documents, such as data integration, data validation, prioritization, and/or workflow processing. In doing so, the ITAC system may be modified to handle flood protection certificates. For example, the ITAC system may be modified with capabilities such as handling invoice processing, commercial and multi-family products, insurance waivers, insurance and flood compliance, force placements, email capabilities, image repository, letter generation, real-time status checking, and/or electronic recon and reporting of compliance review results.

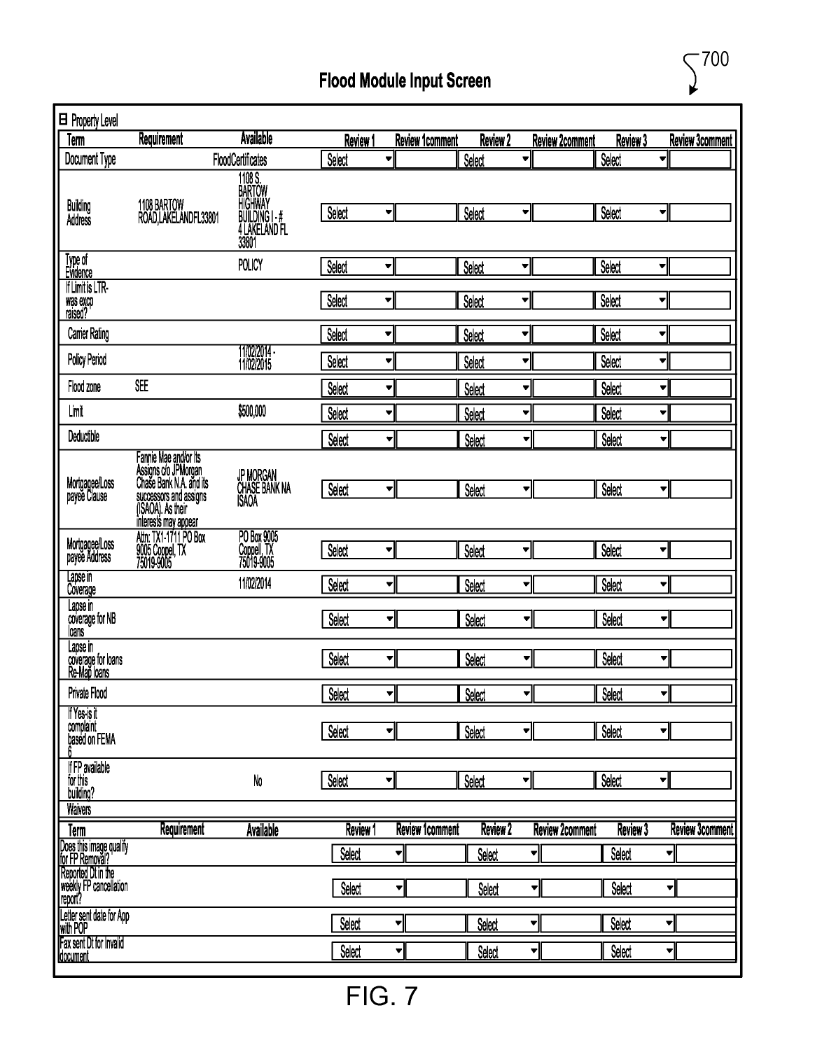

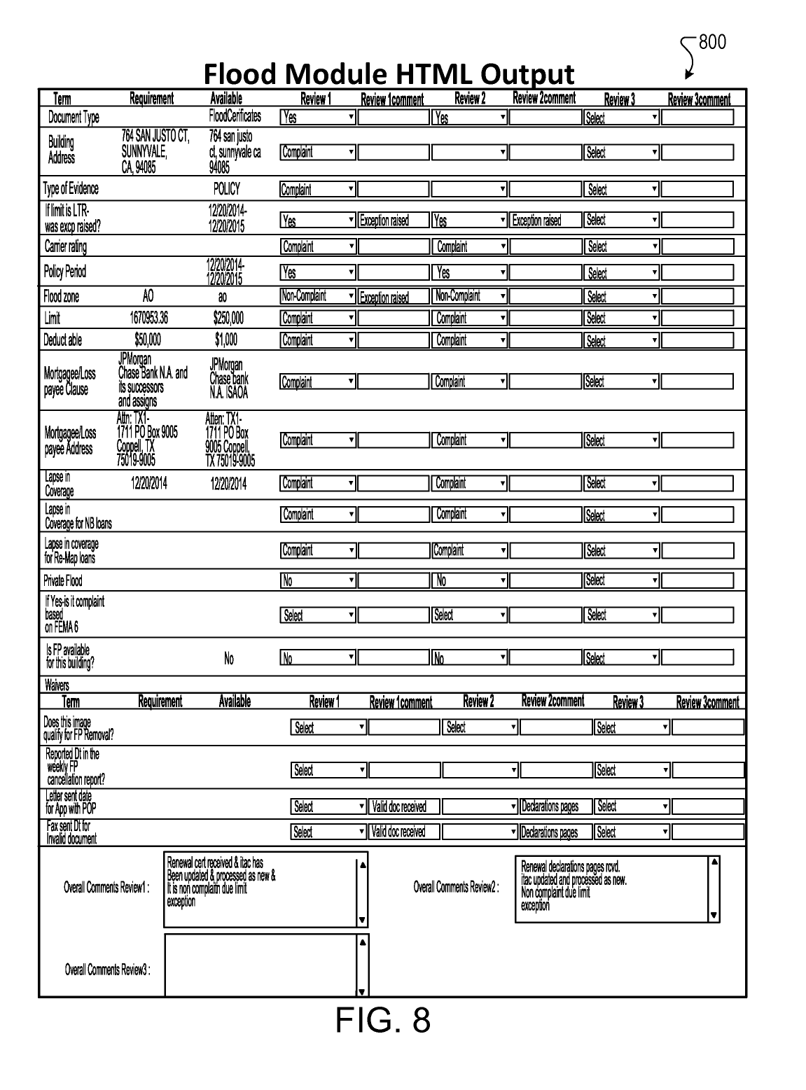

FIGS. 7 to 9 depict examples of graphical user interfaces (GUIs) that may be used for performing compliance review and tracking.

FIG. 7 depicts an example of a user input screen that may be provided by a flood module to enable a user to enter compliance results for one or more parameters of a flood protection certificate. In the example interface 700 of FIG. 7, various parameters may be available to analyze compliance of the flood protection certificate, such as a flood zone, a flood protection policy period, a flood protection limit, a flood protection deductible, or a lapse in flood protection coverage. Other parameters may include a carrier rating, a deductible, and/or other parameters related to analyzing compliance of the flood protection certificate with respect to one or more rules.

FIG. 8 depicts an example of a user output screen that indicates compliance of one or more parameters of a flood protection certificate. In the example output 800 of FIG. 8, the flood module outputs the evaluation results of different parameters and comments from the reviewers. The output of the flood module may be, for example, a HyperText Markup Language (HTML) document that is displayed on a computer screen, such as a mobile device of an employee of a mortgage issuer, or an agent/borrower.

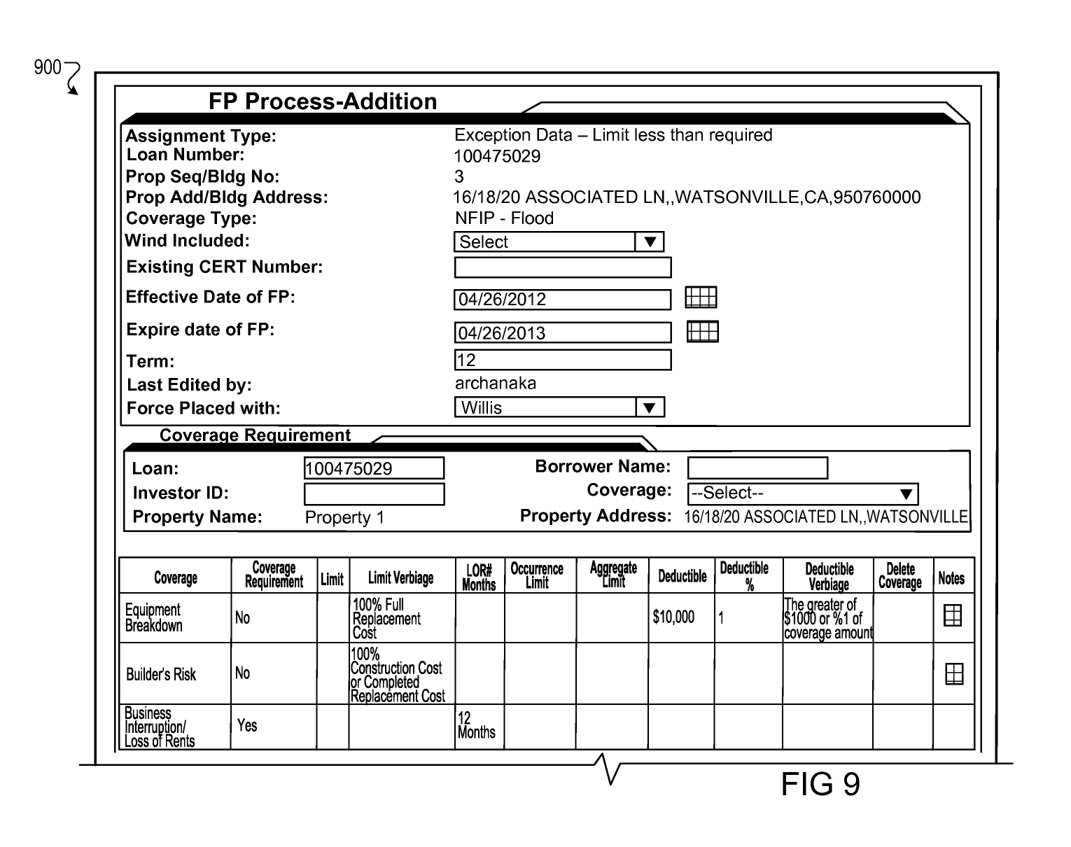

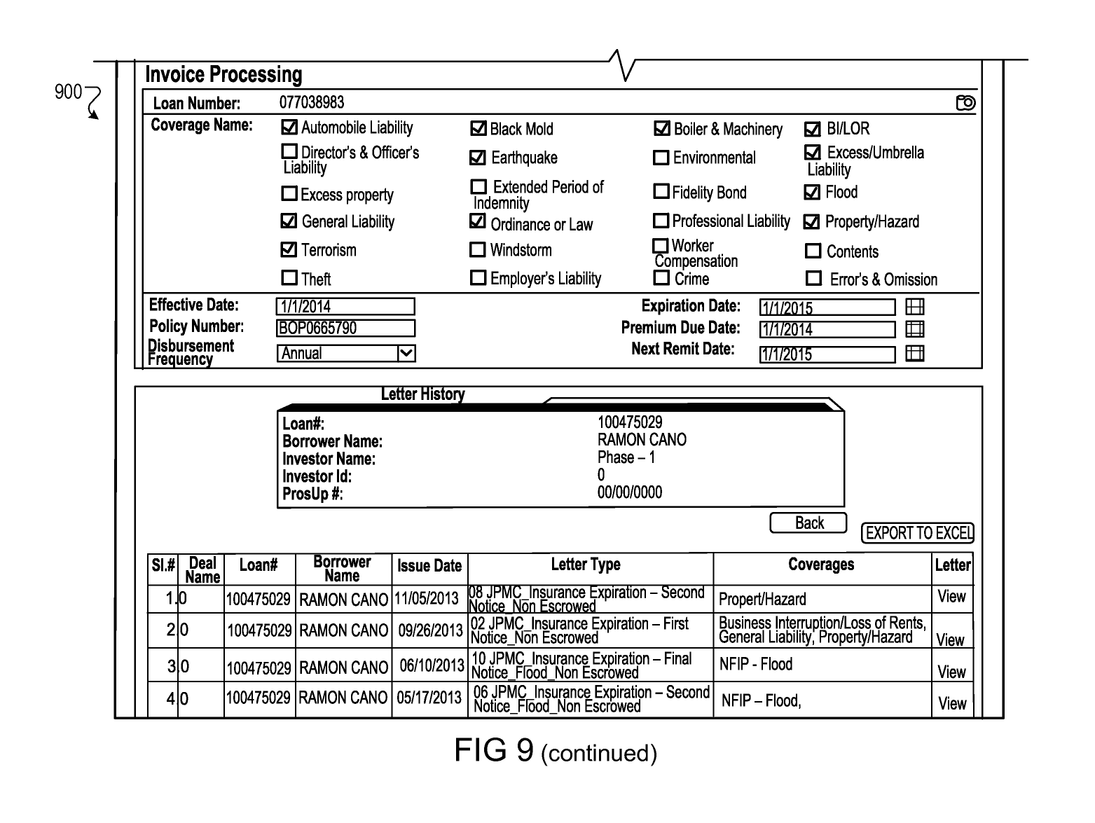

FIG. 9 depicts an example of a user input screen for generating a force-placed flood protection certificate. The flood module may generate a force-placed flood protection certificate, for example, if a borrower consistently fails to remedy deficiencies to comply with flood insurance rules or regulations. In some cases, the system may charge the borrower a premium associated with the force-placed flood protection certificate. In the example input 900 of FIG. 9, the flood module may prompt a user to input various information regarding the force-placed flood protection certificate, such as a term of the policy and identification information for the loan, such as a loan number, associated with the flood protection. Based on the inputs, the flood module may automatically generate a flood protection certificate for the identified loan that complies with the applicable flood-insurance rules and regulations.

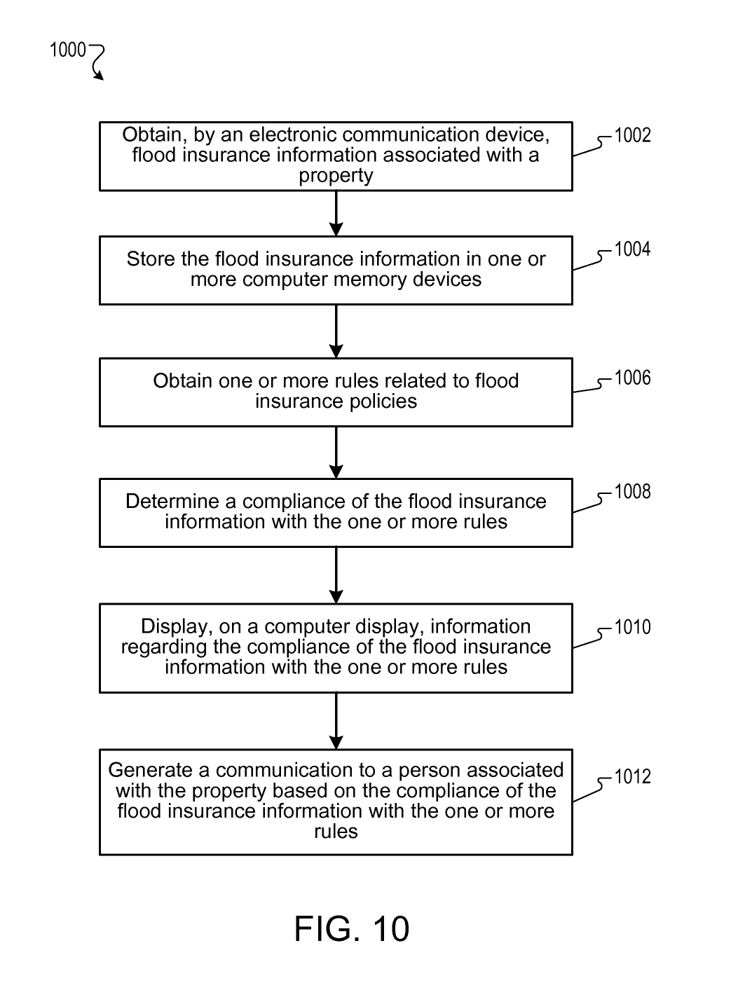

FIGS. 10 to 12 are flow charts depicting examples of performing automated compliance review and tracking of flood protection certificates.

FIG. 10 depicts an example process 1000 of reviewing, tracking, and enabling compliance. In some implementations, the system obtains, by the one or more processors in conjunction with an electronic communications device, a flood protection certificate information associated with a property (1002). The system stores the flood protection certificate information in one or more computer memory devices (1004) and obtains one or more rules that are relevant to the flood protection certificate information (1006). The system then automatically determines a compliance status of the flood protection certificate information with the one or more rules (1008). The system then transmits, by an electronic communication device and based on contact information associated with the property, a result of determining the compliance status of the flood protection certificate information with the one or more rules (1010).

In some implementations, obtaining the flood protection certificate information includes obtaining information related to at least one of a flood zone, a flood protection policy period, a flood protection limit, a flood protection deductible, or a lapse in flood protection coverage. Obtaining the flood protection certificate information may include performing automated recognition of the flood protection certificate information based on one or more naming conventions associated with flood protection policies. In some cases, obtaining one or more rules that are relevant to the flood protection certificate information involves connecting to one or more remote computer servers and obtaining, from the one or more remote computer servers, information related to a government law or a government regulation relevant to the flood protection certificate information.

Determining a compliance status of the flood protection certificate information with the one or more rules may be performed in a number of ways. For example, the system may use information related to a government law or government regulation, such as flood hazard data that indicates flood risk zones, and compare a geographic location of the property with the flood risk zones. In some cases, the system may determine a designated flood protection premium or a designated flood protection rate for the property based on comparing a geographic location of the property with the flood risk zones. Compliance may then be determined by analyzing whether the flood protection certificate information complies with the designated flood protection premium or the designated flood protection rate for the property.

In some cases, determining a compliance status of the flood protection certificate information with the one or more rules involves determining whether the property complies with a requirement to purchase flood protection as a result of receiving flood-related financial assistance from a federal government.

In some examples, determining a compliance status of the flood protection certificate information with the rules involves automatically identifying relevant parameters of the flood protection certificate information, and determining whether the parameters satisfy the rules. In such cases, automatically identifying one or more parameters of the flood protection certificate information may involve automatically determining, based on the flood protection certificate information for the property, parameters related to a flood zone, a flood protection policy period, a flood protection limit, a flood protection deductible, or a lapse in flood protection coverage.

In some cases, the system may determine that the property is not associated with a valid flood protection certificate at all and may thus determine non-compliance.

The system may display, on a display of a mobile electronic device, a graphical user interface displaying information regarding a progress of determining a compliance status of the flood protection certificate information with the one or more rules. In some implementations, the system may obtain a template letter from an electronic storage device, process the template letter to indicate the result of determining the compliance status of the flood protection certificate, and automatically generate a postal transmission of the processed template letter to the contact information associated with the property, indicating the result of determining the compliance status of the flood protection certificate.

In some implementations, the system may establish an electronic communication session with an electronic device associated with the property, and transmit, through the electronic communication session and to the electronic device associated with the property, the result of determining the compliance status of the flood protection certificate information with the one or more rules.

As another example, the system may transmit information indicating at least one deficiency of the flood protection certificate information with respect to the one or more rules and at least one action that would satisfy the at least one deficiency.

The system may also obtain updated flood protection certificate information associated with the property and determine that the updated flood protection certificate information does not comply with the one or more rules. The system may then generate a force-placed flood protection certificate for the property. The system may generate the force-placed flood protection certificate for the property by determining a flood protection premium for the property and generate a flood protection certificate for the property based on the flood protection premium. If the system later determines to cancel the force-placed flood protection certificate, the system may automatically generate a reimbursement for the flood protection premium associated with the force-placed flood protection certificate.

The system may, in some cases, analyze compliance for a plurality of properties, and in doing so, establish a prioritized ordering of analyzing flood protection certificate information for the plurality of properties. The system may determine the prioritized ordering by, for example, performing predictive analytics that identifies one or more high-risk properties from among the plurality of properties, and analyzing those high-risk properties with higher priority.

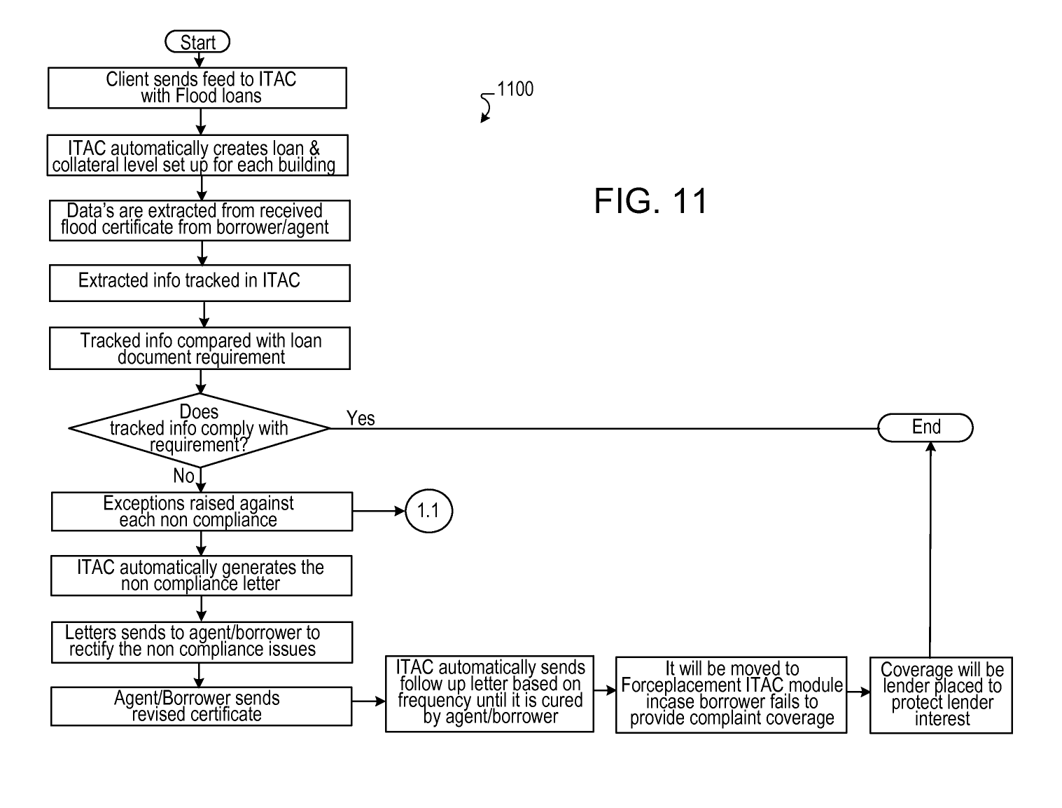

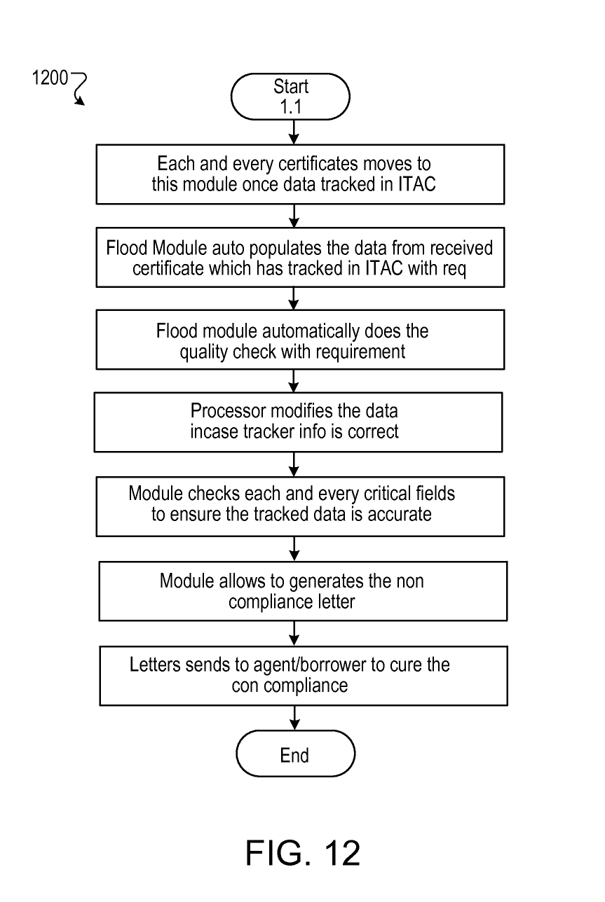

FIG. 11 depicts another example of flood insurance tracking and compliance. In the example process 1100 of FIG. 11, the ITAC system receives a feed from a client regarding flood insurance policies associated with one or more mortgage loans (1102). The ITAC system automatically creates loan and collateral level information for each property associated with the mortgage loan, such as a building (1104). The ITAC system extracts data from the received flood certificates (1106), tracks the extracted information (1108), and compares the tracked information with one or more rules or requirements associated with the loan (1110). If the ITAC system determines (in 1112) that the flood certificate complies with the requirements, then the process ends (1114), and otherwise the ITAC system indicates, such as by raising exceptions, the non-compliant items (1116). Further details of the compliance review, as indicated by 1118, in the context of flood insurance module are presented in FIG. 12.

Based on the non-compliant items detected in operation 1116, the ITAC system automatically generates the non-compliance letter (1120) and sends the non-compliance letters to the agent/borrower, including recommended actions to rectify the non-compliance (1122). The agent/borrower may revise and send an updated flood protection certificate (1124). If the agent/borrower continues to fail to rectify the non-compliance, then the ITAC system continues to send follow-up letters, which may increase in frequency, until the non-compliance is cured by the agent/borrower (1126).

After a sufficient number of repeated follow-up letters, the ITAC system may generate a force-placed flood protection certificate for the agent/borrower (1128), and the force-placed certificate may be lender-placed to protect the lender's interests (1130).

FIG. 12 depicts further details of automatically tracking and reviewing compliance in the context of a flood insurance module. In the example process 1200 of FIG. 12, the flood insurance module performs compliance review on flood certificates that it receives (1204). The flood module automatically extracts data from the received certificates along with applicable rules or requirements (1206) and performs quality checks of the data with respect to the requirements (1208). In some cases, a processor may edit and modify the extracted data to ensure that the data is correct (1210) and the flood module may additionally check certain critical fields to ensure that the data is accurate (1212). The flood module may enable generation of a non-compliance letter to indicate any non-compliant items that the module detected in the certificates (1214), and send the letter to the agent/borrower (1216).

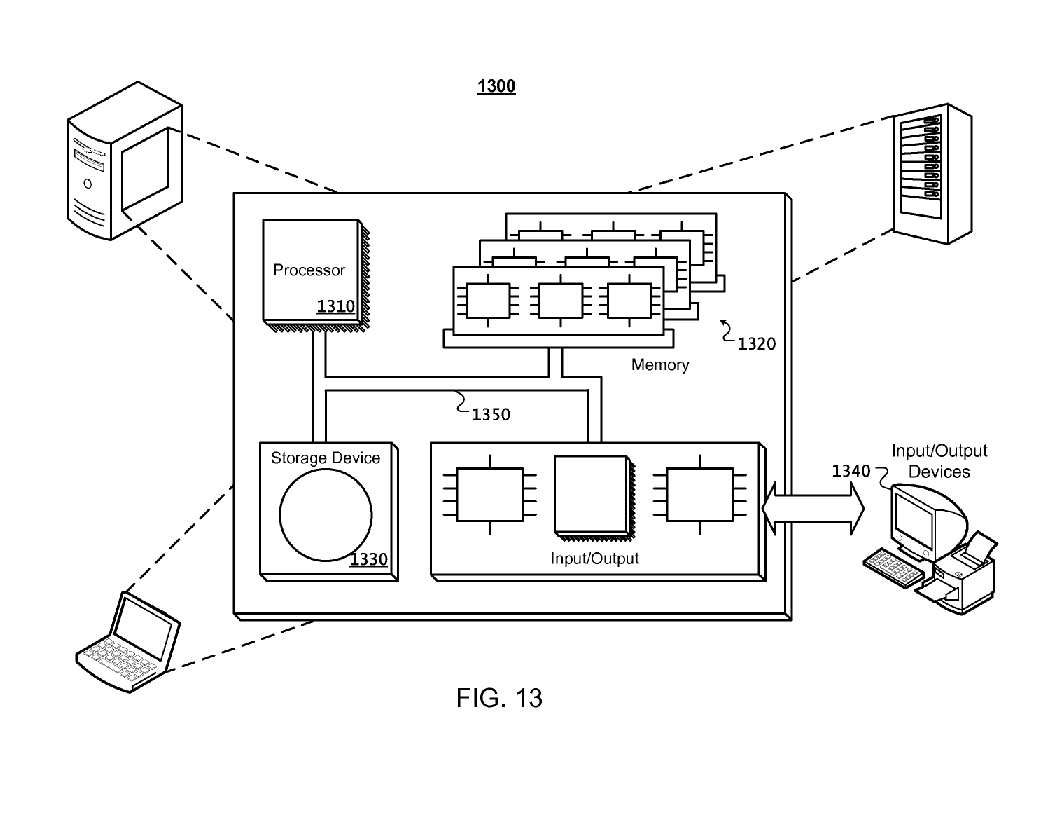

FIG. 13 is a schematic diagram of an example of a computer system that can be used for the operations described in association with the techniques described herein.

The system 1300 includes a processor 1310, a memory 1320, a storage device 1330, and an input/output device 1340. Each of the components 1310, 1320, 1330, and 1340 are interconnected using a system bus 1350. The processor 1310 is capable of processing instructions for execution within the system 1300. In one implementation, the processor 1310 is a single-threaded processor. In another implementation, the processor 1310 is a multi-threaded processor. The processor 1310 is capable of processing instructions stored in the memory 1320 or on the storage device 1330 to display graphical information for a user interface on the input/output device 1340.

The memory 1320 stores information within the system 1300. In one implementation, the memory 1320 is a computer-readable medium. In one implementation, the memory 1320 is a volatile memory unit. In another implementation, the memory 1320 is a non-volatile memory unit. The processor 1310 and the memory 1320 may perform various types of data manipulation.

The storage device 1330 is capable of providing mass storage for the system 1300. In one implementation, the storage device 1330 is a computer-readable medium. In various different implementations, the storage device 1330 may be a floppy disk device, a hard disk device, an optical disk device, or a tape device. The storage device 1330 may store various types of data associated with the techniques described herein.

The input/output device 1340 provides input/output operations for the system 1300. In one implementation, the input/output device 1340 includes a keyboard and/or pointing device. In another implementation, the input/output device 1340 includes a display unit for displaying graphical user interfaces. The input/output device 1340 may be used to perform data exchange with other devices.

The features described can be implemented in digital electronic circuitry, or in computer hardware, firmware, software, or in combinations of them. The apparatus can be implemented in a computer program product tangibly embodied in an information carrier, e.g., in a machine-readable storage device, for execution by a programmable processor; and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit for use in a computing environment.

Processors for the execution of a program of instructions include, by way of example, both general and special purpose microprocessors, and the sole processor or one of multiple processors of any kind of computer. Generally, a processor will receive instructions and data from a read-only memory or a random access memory or both. The elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of implementations have been described. Nevertheless, it will be understood that various modifications may be made without departing from the spirit and scope of the disclosure. Accordingly, other implementations are within the scope of the following claims.

While this specification contains many specifics, these should not be construed as limitations on the scope of the disclosure or of what may be claimed, but rather as descriptions of features specific to particular implementations. Certain features that are described in this specification in the context of separate implementations may also be provided in combination in a single implementation. Conversely, various features that are described in the context of a single implementation may also be provided in multiple implementations separately or in any sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products.

Thus, particular implementations have been described. Other implementations are within the scope of the following claims. For example, the actions recited in the claims may be performed in a different order and still achieve desirable results.

What is claimed is:

1. A computer-implemented method executed by one or more processors, the method comprising:
identifying flood protection certificate information associated with a property;
identifying one or more rules related to the flood protection certificate information;
automatically determining a compliance status of the flood protection certificate information based on the one or more rules; and
providing a result of determining the compliance status of the flood protection certificate information with the one or more rules.

2. The method of claim 1, wherein identifying the flood protection certificate information includes obtaining information related to at least one of a flood zone, a flood protection policy period, a flood protection limit, a flood protection deductible, or a lapse in flood protection coverage.

3. The method of claim 1, wherein identifying the flood protection certificate information comprises automatically recognizing the flood protection certificate information based on one or more naming conventions associated with flood protection policies.

4. The method of claim 1, wherein obtaining one or more rules that are relevant to the flood protection certificate information comprises:
retrieving, from one or more remote computer servers, information related to a government law or a government regulation related to the flood protection certificate information.

5. The method of claim 4, wherein determining a compliance status of the flood protection certificate information with the one or more rules comprises:
determining, based on the information related to the government law or government regulation, flood hazard data that indicates one or more flood risk zones;
comparing a geographic location of the property with the one or more flood risk zones;
determining a designated flood protection premium or a designated flood protection rate for the property based on comparing a geographic location of the property with the flood risk zones; and
determining whether the flood protection certificate information complies with the designated flood protection premium or the designated flood protection rate for the property.

6. The method of claim 1, wherein determining a compliance status of the flood protection certificate information with the one or more rules comprises:
determining whether the property complies with a requirement to purchase flood protection as a result of receiving flood-related financial assistance from a federal government.

7. The method of claim 1, wherein determining a compliance status of the flood protection certificate information with the one or more rules comprises:
automatically identifying one or more parameters of the flood protection certificate information; and
determining whether the one or more parameters of the flood protection certificate information satisfies the one or more rules.

8. The method of claim 7, wherein automatically identifying one or more parameters of the flood protection certificate information comprises:
automatically determining, based on the flood protection certificate information for the property, one or more parameters related to a flood zone, a flood protection policy period, a flood protection limit, a flood protection deductible, or a lapse in flood protection coverage.

9. The method of claim 1, wherein determining a compliance status of the flood protection certificate information with the one or more rules comprises:
determining that the property is not associated with a valid flood protection certificate.

10. The method of claim 1, further comprising displaying, on a display of a mobile electronic device, a graphical user interface displaying information regarding a progress of determining a compliance status of the flood protection certificate information with the one or more rules.

11. The method of claim 1, wherein providing the result of determining the compliance status of the flood protection certificate information with the one or more rules comprises:
transforming a template letter to indicate the result of determining the compliance status of the flood protection certificate information; and
automatically generating a postal transmission of the transformed template letter indicating the result of determining the compliance status of the flood protection certificate information, wherein the postal transmission is addressed to contact information associated with the property.

12. The method of claim 1, wherein providing the result of determining the compliance status of the flood protection certificate information with the one or more rules comprises:
transmitting, over an electronic network to an electronic device associated with the property, the result of determining the compliance status of the flood protection certificate information with the one or more rules.

13. The method of claim 1, wherein providing the result of determining the compliance status of the flood protection certificate information with the one or more rules comprises:
transmitting information indicating at least one deficiency of the flood protection certificate information with respect to the one or more rules and at least one corrective action associated with the at least one deficiency.

14. The method of claim 1, further comprising:
obtaining updated flood protection certificate information associated with the property;
determining that the updated flood protection certificate information does not comply with the one or more rules; and
based on determining that the updated flood protection certificate information does not comply with the one or more rules, generating a force-placed flood protection certificate for the property.

15. The method of claim 14, wherein generating a force-placed flood protection certificate for the property comprises:
determining, based on the one or more rules, a flood protection premium for the property; and
generating a flood protection certificate for the property based on the flood protection premium.

16. The method of claim 15, further comprising:
determining a cancellation of the force-placed flood protection certificate; and
generating a reimbursement for the flood protection premium associated with the force-placed flood protection certificate.

17. The method of claim 1, further comprising generating, for a plurality of properties, a prioritized ordering of analyzing flood protection certificate information for the plurality of properties.

18. The method of claim 17, wherein generating the prioritized ordering comprises performing predictive analytics that identifies one or more high-risk properties from among the plurality of properties.

19. A system comprising:
one or more computers; and
a computer-readable medium coupled to the one or more computers having instructions stored thereon which, when executed by the one or more computers, cause the one or more computers to perform operations comprising:
identifying flood protection certificate information associated with a property;
identifying one or more rules related to the flood protection certificate information;
automatically determining a compliance status of the flood protection certificate information based on the one or more rules; and
providing a result of determining the compliance status of the flood protection certificate information with the one or more rules.

20. A computer storage medium encoded with a computer program, the computer program comprising instructions that when executed by one or more processors cause the one or more processors to perform operations comprising:
identifying flood protection certificate information associated with a property;
identifying one or more rules related to the flood protection certificate information;
automatically determining a compliance status of the flood protection certificate information based on the one or more rules; and
providing a result of determining the compliance status of the flood protection certificate information with the one or more rules.
